(19) United States
(12) Patent Application Publication
(10) Pub. No.: US 2009/0058707 A1
(43) Pub. Date: Mar. 5, 2009

(54) DUAL MODE REMOTE CONTROL SYSTEM

(75) Inventors: Jason Craze, Orange, CA (US); Gilbert Liu, Riverside, CA (US); Kris Wu, Diamond Bar, CA (US); Todd Stanchfield, Saugus, CA (US)

Correspondence Address: HOGAN & HARTSON L.L.P., 1999 AVENUE OF THE STARS, SUITE 1400, LOS ANGELES, CA, 90067, US

(73) Assignee: SpeakerCraft, Inc.

(21) Appl. No.: 11/848,151

(22) Filed: Aug. 30, 2007

(51) Int. Cl. H04L 17/02

(52) U.S. Cl. 341/176

(57) ABSTRACT

A remote control system includes a plurality of devices located in a plurality of zones in an operational area. A controller is coupled to and controls the plurality of devices. A handheld control device includes a first wired interface and a wireless transmitter. The wireless transmitter commands the controller to control a first set of devices selected from the plurality of devices. A docking station is located in one of the plurality of zones. The docking station is connected to the controller through a wired network and has a second wired interface connectable with the first wired interface when the handheld control device is docked such that the handheld control device connects to the controller through the wired network to control a second set of devices selected from the plurality of devices. The second set of devices is different from the first set of devices.

### BACKGROUND OF THE INVENTION

1. Field of the Invention

This invention relates to a dual mode remote control system for use in media delivery and system control.

2. Description of Related Art

Audio/Video home entertainment systems have become increasingly popular. With the proliferation of devices such as CD players, DVD players, media servers, satellite receivers, etc., that can be provided throughout a home, the unified and convenient control of these devices has become difficult. In attempts to solve this problem, wired controllers such as fixed, in-wall keypad controllers are known to control media devices connected to a media source controller. Keypad controllers can be mounted into a wall and can be connected to a media source controller using CAT 5 cables or similar wiring. However, fixed keypad controllers have the downside of being stationary.

In other conventional systems, remote controls are provided in conjunction with keypad controllers and allow remote operation of media devices, typically using radio frequency signals. Although a fixed controller and remote control allow media device control with greater convenience, they operate using different communication methods having different reliability and communication protocols. Furthermore, the layout and functionality of a fixed keypad is designed for wall viewing and interaction while standing. Remote control devices are, however, portable and are provided with an appropriate interface. One problem with these systems is that having both an in-wall keypad and a remote control burdens the user with learning multiple interfaces. Also, developing independent control schemes to control the same source devices has the disadvantage of adding to the development and production costs for manufacturers.

Conventionally, remote control devices are not equipped to handle both wireless communication and wired communication and allow them to switch seamlessly between them. For example, remote control batteries are often recharged at a docking station. However, the docking station is simply a charging base and does not connect to a wired network.

### SUMMARY OF THE INVENTION

Various embodiments of the present invention overcome these drawbacks of the prior art and provide a dual mode remote control system with a control device that controls source devices over a wired network or through a wireless transmitter depending on how and where the keypad is connected to the system. Different devices or features can be controlled depending on the mode of the keypad.

Accordingly, one embodiment of the invention is a remote control system that includes a plurality of devices located in a plurality of zones in an operational area. A controller is coupled to and controls the plurality of devices. A handheld control device includes a first wired interface and a wireless transmitter. The wireless transmitter commands the controller to control a first set of devices selected from the plurality of devices. A docking station is located in one of the plurality of zones. The docking station is connected to the controller through a wired network and has a second wired interface connectable with the first wired interface when the handheld control device is docked such that the handheld control device connects to the controller through the wired network to control a second set of devices selected from the plurality of devices. The second set of devices is different from the first set of devices.

In another embodiment of the present invention, a remote control system includes a plurality of devices located in a plurality of zones in an operational area. A controller is coupled to and controls the plurality of devices. A handheld control device has a first wired interface and a wireless transmitter. The wireless transmitter commands the controller to control a first set of devices selected from the plurality of devices using a first set of commands. A docking station is located in one of the plurality of zones. The docking station is connected to the controller through a wired network. The docking station has a second wired interface connectable with the first wired interface when the handheld control device is docked such that the handheld control device connects to the controller through the wired network to control a second set of devices using a second set of commands.

A method for remotely controlling a plurality of devices within a plurality of zones in an operational area includes providing a docking station within one of the plurality of zones. The docking station is coupled to the plurality of devices through a wired network. A handheld control device is connectable with the docking station and has a wireless transmitter. The method automatically allows control of a first set of devices selected from the plurality of devices by the handheld control device through the wired network when the handheld control device is connected to the docking station. The method automatically allows control of a second set of devices selected from the plurality of devices by the handheld control device through the wireless transmitter when the handheld control device is not connected to the docking station. In one embodiment, the first set of devices is different from the second set of devices. In another embodiment, the handheld control device controls different features of the first or second set devices depending on whether it is connected to the docking station.

Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1 is a block diagram one embodiment of a remote control system of the invention.

FIG. 2 is a block diagram of one embodiment of a keypad, docking station and controller combination of the invention.

FIG. 3 is a perspective view of the keypad and docking station shown in FIG. 1.

FIG. 4 is a flow diagram showing the transition from wired to wireless communication according to one embodiment of the invention.

FIG. 5 is a circuit block diagram of the keypad and docking station according to one embodiment of the invention.

FIG. 6 is a flow diagram showing the transition from wireless to wired communication according to one embodiment of the invention.

FIG. 7 is a flow diagram showing a method for connecting a keypad to a wired or wireless network according to one embodiment of the invention.

FIG. 8 is a flow diagram showing the operation of a controller according one embodiment of the invention.

### DETAILED DESCRIPTION OF THE INVENTION

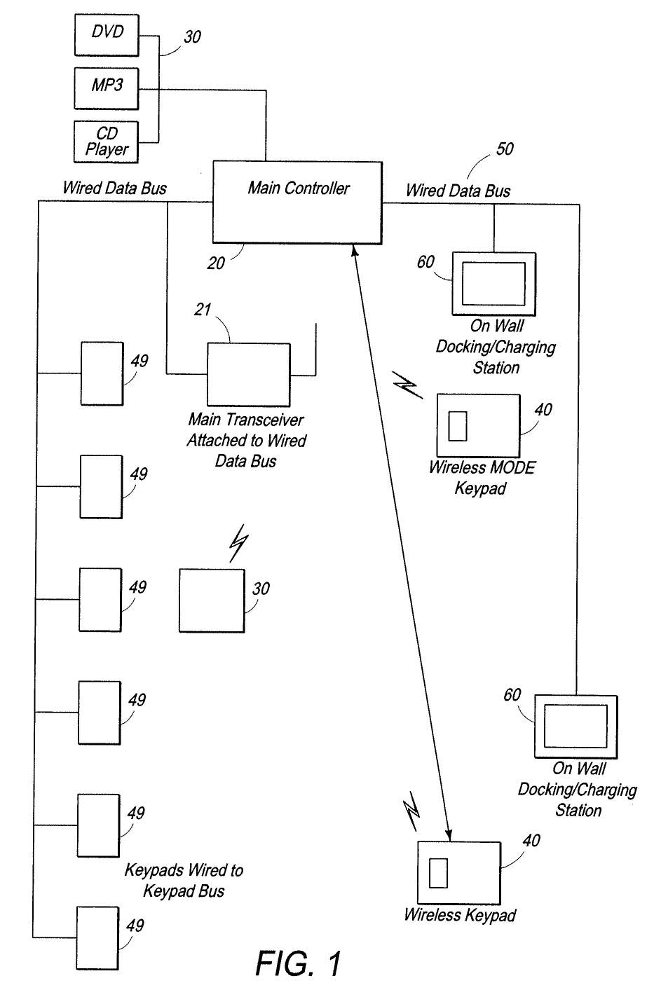

One embodiment of a dual mode remote control system 10 is illustrated in FIG. 1 and can be used in an audio/video distribution network to control a plurality of devices 30. The system 10 includes a main controller 20 connected to a plurality of devices 30, such as DVD players, mp3 players, home audio systems, satellite receivers, automated drapes and shades, clocks, HVAC systems, lighting systems, etc. The devices are located in a plurality of locations, or zones, within an operational area of the remote control system, and can communicate with the controller through a wired bus 50 or wirelessly through a transmitter 48. The main controller 20 receives commands from various immobile and handheld control devices, such as in-wall keypads 49 and portable keypad control devices 40, respectively, and translates them into commands suitable to control any of the devices 30. Controller 20 also retrieves data such as volume level, track selection, time elapsed, etc., from the devices 30 to be displayed on the keypad 40.

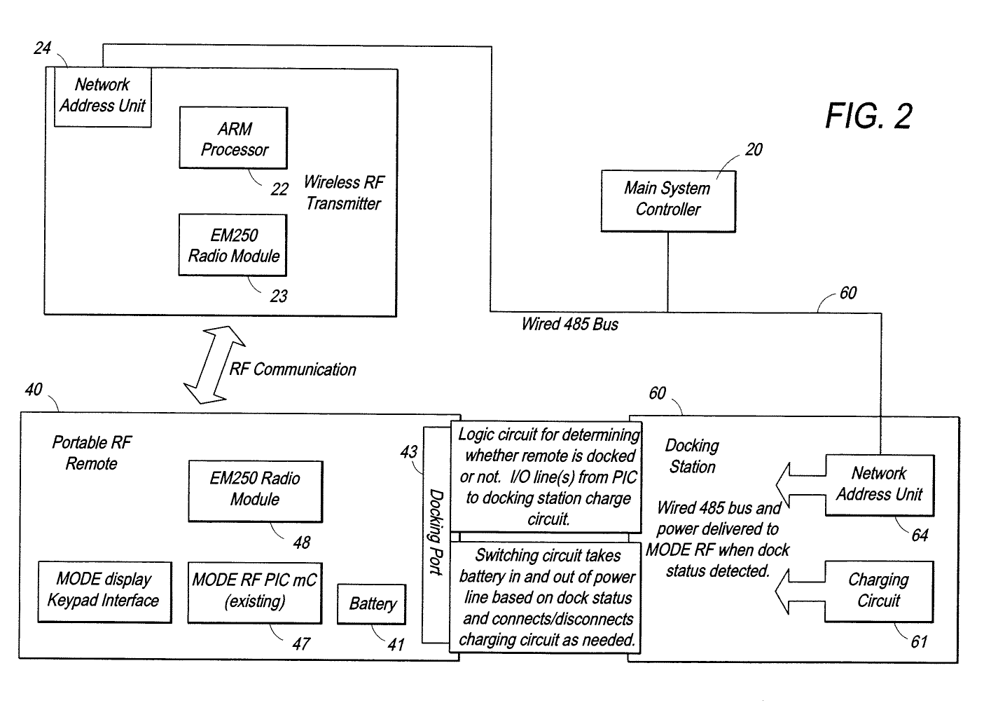

A wired data bus 50 is provided to connect the main controller 20 with an in-wall docking station 60. A transceiver 21 is also connected to the bus 50 to receive RF communication from keypad 40. The transceiver 21 includes an ARM processor 22 and an EM250 radio module. ARM processors are common in mobile electronics and the EM250 radio module is a ZigBee compliant radio transceiver. A network address unit 24 connects the transmitter 21 to the wired bus 50. Docking station 60 includes a similar network address unit 64. The bus 50 operates under the RS 485 communication protocol using Ethernet cabling that can be run between the walls of a home. Furthermore, the wired network connection can utilize MAC/PHY for a wired network connection so as to allow the system 10 to have an Ethernet backbone rather than RS 485. In this manner, the controller 20 would have an IP address and MAC address. As shown in FIG. 2, the keypad 40 transmits commands to controller 20 via the wired docking station 60 or transmitter 48. The structure of the keypad 40 and docking station 60 will be described in detail below.

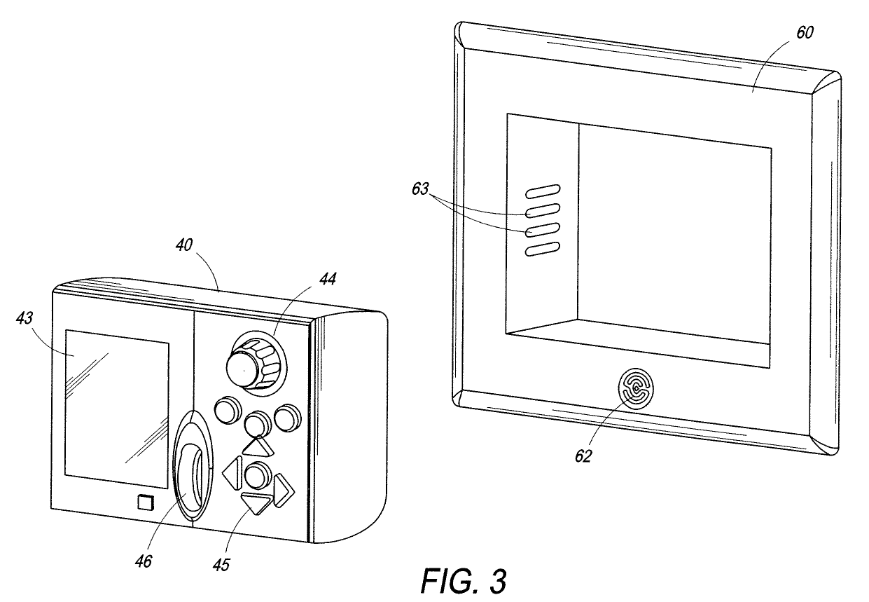

In FIG. 3, the docking station 60 is shown mounted into a wall of a room. Docking station 60 is provided with a hollow space for the keypad 40 to be inserted so that docking station 60 can be mounted flush with the wall. Furthermore, a charging unit 61 is provided in the docking station 60 to recharge the battery 41 of keypad 40. The charging unit 61 can deliver power and data to keypad 40 via contacts 63. A button release 62 is provided to allow a user to remove keypad 40 from housing unit 60 when portable use is desired. When the portable keypad 40 is out of the wall, a spring plate or similar device takes the place of the keypad so that the hollow space is not visible to the user. The docking station 60 is connected to the main controller 20 via a wired network connection. Moreover, a table top charging station can be provided to recharge the portable keypad 40. In this embodiment, the table top charging station does not connect to the wired network. However, it is within the scope of the invention for a table top charging station to connect to the controller through the wired network or through a separate wireless transceiver on the table top charging station. The wall mounted docking station may alternatively function as a charging station without connection to the wired network.

Keypad 40 includes a display 43 such as a color LCD screen, programmable hard keys 45, a volume control knob 44, and a scroll wheel 46 having a click button. Keypad 40 provides an interface for users to control devices 30 and display relevant status information and options for those devices. A touch panel may be used as a user interface in place of the hard keys to accept user input. The touch panel includes a full-size LCD with a touch overlay. The keypad can dock to a docking station using a wired interface, such as through electrical contacts, electrical cable, or the like. A microcontroller 47, such as a PIC processor or ARM processor, processes the inputs and outputs of the keypad 40. A speaker and microphone are provided for audio input and feedback (not shown). An optional backlight provides a visual indicator of a volume level and optional IR sensor receives IR signal from other control devices (not shown). The handheld, or rear, portion of the keypad is provided with a rubber “sleeve” that allows comfortable handling of the keypad when used portably. The keypad also includes intercom functionality. For example, a “page” button provided on the keypad allows a user to speak into the microphone of the keypad so as to be distributed to any of the speakers throughout the system, such as through the speakers in the other keypads. The intercom feature allows the keypad to serve as an audio source as well as a command source.

The keypad includes a wireless transmitter 48 to wirelessly connect to transceiver 21 and a docking port 43 to form a physical, wired interface to docking station 60. In this embodiment, the keypad is supported by the docking port 43, but it is also within the scope of the invention for the keypad 40 to be electrically connected to, but not supported by, the docking station, such as through an electrical cable or the like. Transmitter 48 can be an EM 250 radio module with an antenna that is embedded in the keypad housing. The wireless network connection utilizes the ZigBee radio frequency protocol with the transmitter 48. The keypad 40 operates on both a wired RS 485 network and a wireless ZigBee network, depending on whether or not the keypad is docked. Keypad 40 automatically switches between these wired and wireless networks when it is docked and undocked. This feature allows the user to control the system 10 with the same device and interface at either a fixed position or portably without interruption.

Furthermore, keypad 40 changes its default functionality based on whether it is docked or undocked. To provide different functionality, each device 30 is assigned to a zone and given a zone address, which is based on the location of the device within an operational area, for example, a master bedroom. All devices connected to the system that are within an operational area are assigned to a particular zone based on their location. A plurality of zones for a plurality of devices can be provided. In this embodiment, the set of devices under control of the keypad is different depending on whether the keypad is docked or undocked. When undocked, the keypad 40 assumes control of multiple zones in the operational area by sending commands from the transmitter 48 to the wireless transceiver 21, which are transmitted to controller 20. Although FIGS. 1 and 2 depict the wireless transceiver 21 as separate from the controller, it is also within the scope of the invention for the wireless transceiver 21 to be part of or co-located with the controller. When undocked, the devices under keypad control can be a subset of devices greater than the devices under control when docked to the docking station. For example, an undocked keypad can control all of the devices controlled by a docked keypad, as well as other devices. In this manner, the set of devices under docked control is a subset of the devices under undocked control. Allowing the undocked keypad to control devices in multiple zones gives the user greater freedom to use the keypad while moving from one location to another. Each docking station 60 is associated with a zone, and multiple devices and docking stations can be associated with a single zone. A table top charging station is provided to recharge the keypad and can also be associated with a zone based on its location.

In one embodiment, a docked keypad 40 controls only the devices within the zone of the docking station 60. Furthermore, a docked keypad 40 may initially allow control only of devices in the docked zone, but still allow a user to override the system to control additional zones. In this manner, docked keypads default to control of the docked zone, but a user can go to a menu that allows control of other zones. Also, when a keypad is docked, the user may be prompted to change the zone of the docking station location instead of automatically changing the zone. Therefore, a docked keypad can control all the devices within a location, and in some cases, additional locations. Different sets of devices may be controlled when the remote is docked versus undocked in a particular zone, but these different devices do not all need to be associated with or be in a particular zone.

In another embodiment, a docked keypad 40 allows control of devices in the docking station zone with different functionality than when the keypad is undocked. For example, it can be desirable to limit access to television parental controls only to parents such that the keypad must be docked in the parents' bedroom in order to access that functionality. In the undocked state, the keypad has access to a limited set of commands to control a television. In the docked state, the keypad is given access to the full set of commands to control the television. The sets of commands available to control devices in a keypad in an undocked and docked state are different. In another embodiment, an undocked keypad is able to control more devices, but a docked keypad has greater control over a smaller number of devices. In another embodiment, the undocked keypad can control a different, but overlapping set of devices as those it would control when docked. In other words, some of the devices under the control of a docked keypad may be excluded altogether from the control of an undocked keypad. Therefore, access to a restricted device can be limited to keypads docked in a particular docking station. Furthermore, the keypad can retain control over the last associated zone when the keypad is undocked. For example, if a user is docked into the living room zone and takes the keypad out for use on the couch, the keypad will, by default, still control the devices in the living room as if it were docked in the living room docking station. Users are thus provided with seamless convenience and enhanced usability.

Moreover, controller 20 tracks the location of keypads by assigning addresses to each keypad and docking station. Each keypad is assigned a MAC address to identify the keypad to the controller during wireless transmission. Each docking station is provided a zone address. The MAC address acts as a wireless networking addressing scheme which supplements the zone addresses of the wired network. This dual addressing scheme allows multiple systems with multiple keypads to operate in close proximity to each other without interference. When a keypad is docked to the docking station and communication switches from the wireless transmitter 48 to the wired network, the zone address of the docking station is associated with the keypad. The addressing unit 64 of docking station 60 provides keypad 40 with the zone address, and keypad 40 can control the devices of that zone.

Keypads can also track each other. Changes made by one keypad for a selected device are seen and displayed on another keypad that has selected the same device. For example, a keypad docked in the kitchen that has selected the speakers in the living room can see the changes made by a keypad in the living room that is increasing the volume of the speakers. Changes within a zone can also be tracked by the keypads in a similar manner.

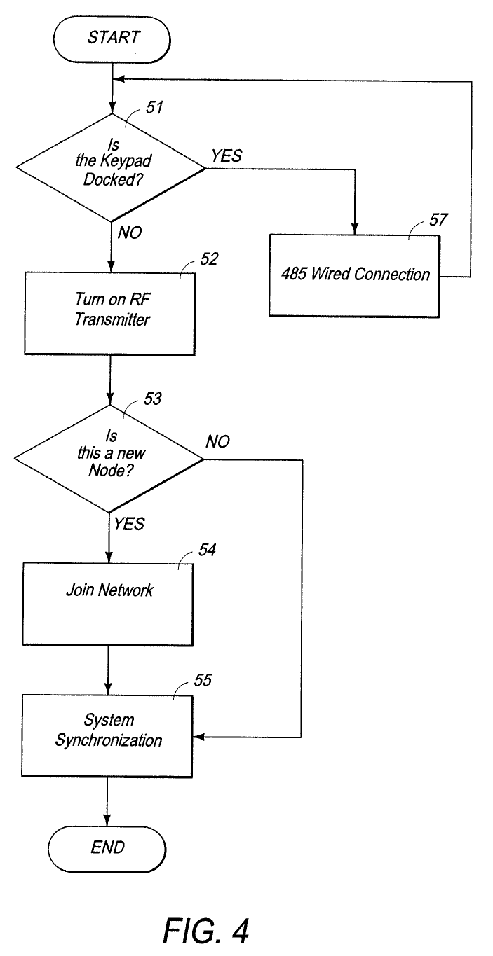

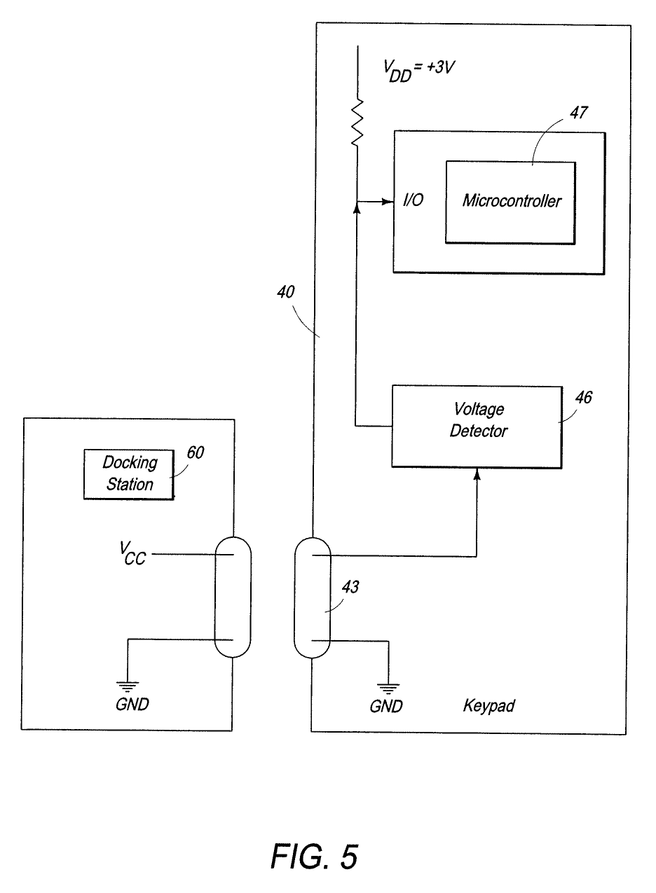

A keypad 40 docked to the docking station 60 will communicate using the wired network until the keypad is removed from the docking station 60. FIG. 4 describes the process of switching from the wired network to the wireless network. The process begins at step S1 when keypad 40 detects whether or not the keypad is docked to the docking station 60. If docked, the keypad determines in step S7 that the network connection to controller 20 is wired and the process returns to step S1. The keypad is determined to be undocked when voltage detector 46 (FIG. 5) detects a drop in threshold voltage that is below a pre-determined minimum value for a pre-determined period of time. Then, the keypad 40 turns on transmitter 48 in step S2 and performs a network link status request by transmitting the keypad's MAC address to wireless transceiver 21. A reply is received and at step S3, controller 20 determines if the keypad is a new node in the wireless network. If the MAC address was previously assigned a wireless channel, then the keypad 40 is not a new node, and the keypad synchronizes with the controller 20 in step S5. However, if the keypad 40 is a new node on the wireless network that has not been registered with controller 20, or if the wireless network has been reset, then the keypad requests to join the network in step S4 and is given a unique wireless channel associated with the transmitted MAC address. Synchronization at step S5 includes downloading the current zone and source information. In this manner, when a user takes the keypad out of the docking station and disconnects from the wired network, the wireless transmitter automatically turns on and joins the wireless network to allow continuous operation of the keypad.

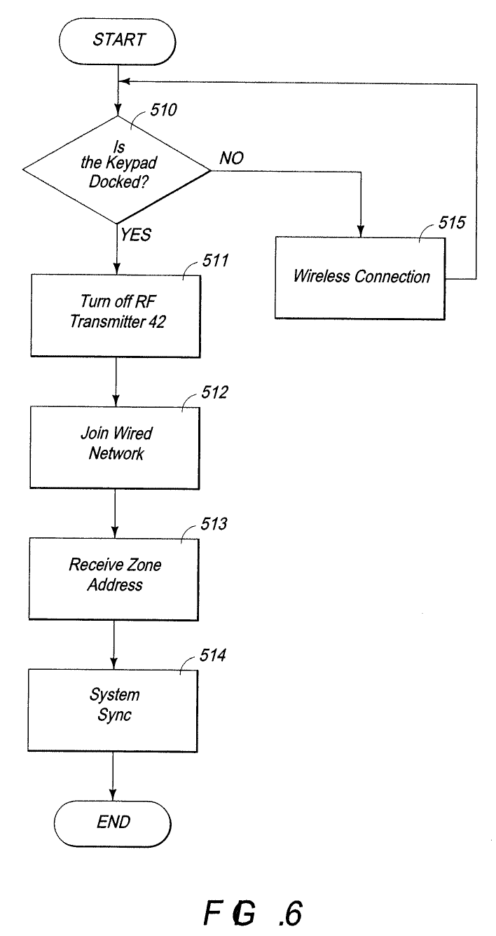

A keypad that is undocked will communicate using the wireless network until the keypad is inserted into the docking station. FIG. 6 describes the process of switching from the wireless network to the wired network. The process begins at step S10 when keypad 40 detects whether or not the keypad is docked to the docking station 60. If not docked, the keypad determines in step S15 that the network connection to controller 20 is wireless and the process returns to step S10. The keypad is determined to be docked when keypad 40 receives a stable threshold voltage from docking station 60 for a predetermined amount of time. For example, the keypad can be set to wait two seconds before detecting that the keypad is docked, to ensure that the keypad is firmly inserted into the docking station and that a wireless connection is not prematurely ended. The wireless transmitter 48 is then turned off at step S11 once a wired network is detected and a stable voltage is reached. At step S12, the keypad joins the wireless network and at step S13, receives the zone address of the docking station from addressing unit 64. At step S14, the keypad is synchronized with the source and zone information using the wired network. In this manner, keypad 40 transitions from a wireless network to a wired network after a stable wired connection is detected, such that continuous operation of the keypad is guaranteed.

In one embodiment of the invention, a polling communication protocol is used for the wired network and a non-polling communication protocol is used for the wireless network. In the wired network, the controller scans, or polls, the keypads of each zone until a command is detected. The controller then executes the command and sends a busy status signal to all the keypads in the other zones prohibiting further commands. For example, if a keypad sends a “previous song” command to controller 20, then controller 20 executes the command and broadcasts a busy status signal to all other keypads until the command is finished executing. Then, the controller returns to polling the keypads for the next command.

A wireless connection that utilizes a polling protocol is inefficient since every keypad would be scanned and data loss due to transmission error would require data to be constantly resent. In view of these problems, the controller of the invention uses a non-polling protocol to improve the efficiency and accuracy of the wireless network communication. In the non-polling protocol, before a command is sent by the keypad, a talk request is first transmitted to the controller. Once the controller accepts the talk request, the keypad sends the command. The non-polling protocol allows a secure communication channel with the controller that reduces the traffic rate and time out conditions of commands sent from a plurality of keypads.

Furthermore, an intelligent broadcast technique can be applied to the non-polling protocol. The keypad that sends out a command, known as the controlling keypad, first sends out a talk request. Once a talk request is approved by the controller and a command is subsequently received, the controller will send a system status message to the controlling keypad that the command was sent successfully. In response, the keypad will send an Acknowledgment message (ACK). If an ACK is not received, the controller will resend the system status message to the controlling keypad. In the intelligent broadcast technique, the system status message is sent only to the controlling keypad and not to the other keypads, further saving bandwidth. The non-controlling keypads will be updated with the same information when the controller provides a system wide broadcast message. In an alternative embodiment of the intelligent broadcast technique, the system status message is sent to the controlling keypad that sent the command as well as other docked keypads that are in the same zone as the controlling keypad. In this manner, the keypads within a zone can be quickly updated with the most relevant status information, while the remaining keypads are updated during a system wide broadcast message.

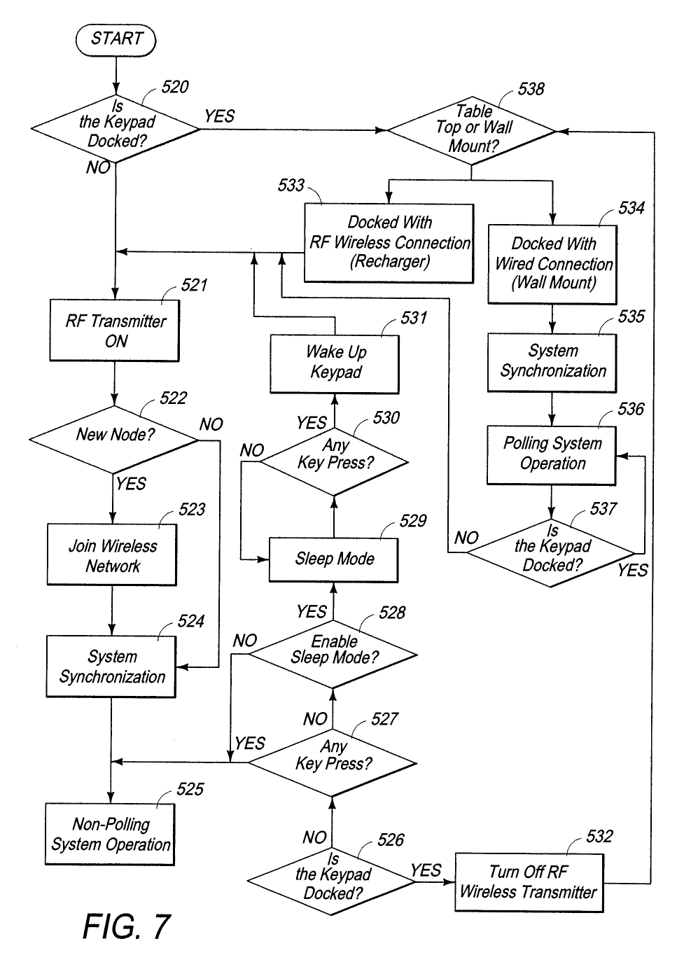

Accordingly, the flowchart of FIG. 7 will describe the operation of keypad 40 using the polling and non-polling communication. The process begins at step S20 when keypad 40 detects whether or not the keypad is docked to the docking station 60. If the keypad is docked but a wired connection is not detected, then the keypad determines in step S38 that the keypad is docked in a table top recharging dock. In this case, the keypad is able to recharge its battery 41 at step S33 and proceeds to step S21 to connect to the wireless network. If the keypad is docked into a wall unit, then the keypad connects to the wired network at step S34. The keypad then synchronizes source and zone information at step S35 and begins the polling process with the controller, as described above, at step S36. If the keypad becomes undocked at step S37, the process then proceeds to step S21.

At step S21, keypad 40 turns on transmitter 48 and performs a network status request by transmitting the keypad's MAC address to wireless transceiver 21. Step S22 determines if the keypad is a new node in the wireless network. If the MAC address was previously assigned a wireless channel, then the keypad 40 is not a new node, and the keypad synchronizes with the controller 20 in step S24. However, if the keypad is a new node on the wireless network that has not been registered with the controller, or if the wireless network has been reset, then the keypad requests to join the wireless network in step S23 and is given a unique wireless channel associated with the transmitted MAC address. Synchronization at step S24 includes downloading the current zone and source information. Then, communication between the keypad and controller is performed using the non-polling protocol at step S25. If the keypad detects a docking operation at step 26, the wireless transmitter 48 is turned off at step S32 and the keypad determines at step S38 whether it is docked at a recharging unit or in a wall unit. Otherwise, the keypad waits for a button press at step S27. If no input is forthcoming, the keypad determines in step S28 if sleep mode should be enabled. If so, then the keypad enters sleep mode at step S29 until a button press is detected at step S30. At this point the keypad is woken up and the process returns to step S21. As described above, the non-polling wireless connection can be provided in conjunction with the polling wired connection to allow a single keypad to control the system in either wired or wireless mode.

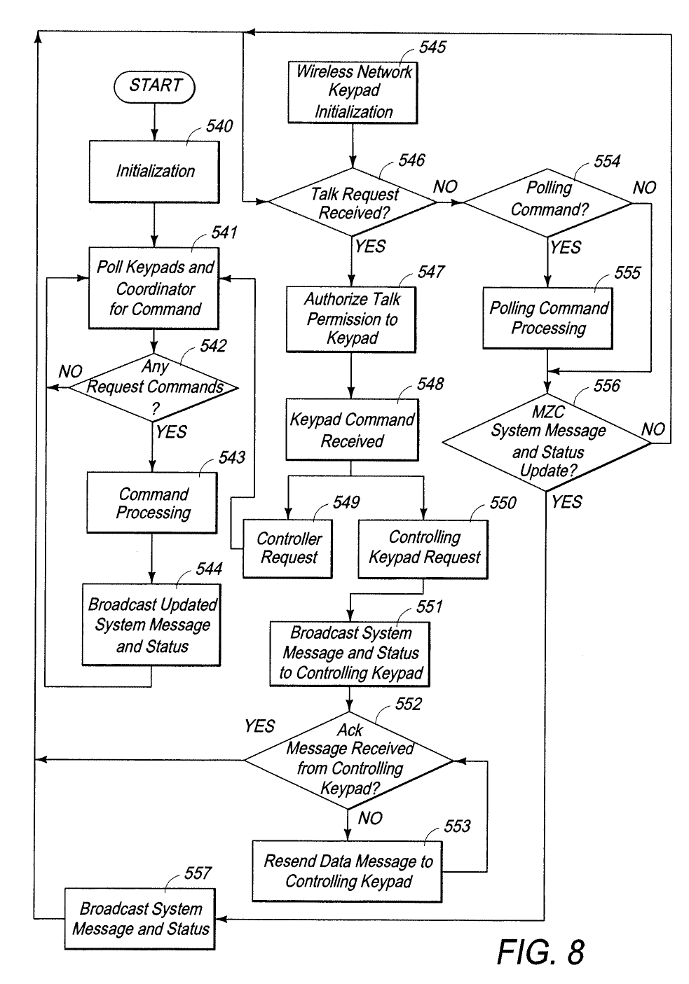

FIG. 8 describes the operation of the controller and the manner the system provides polling and non-polling operation, as well as system updates. The controller initializes at step S40 and then begins at step S41 to continuously poll the keypads for commands. When a command is received at step S42, the controller processes the commands at step S43 and then broadcasts a system update message and status update to all the keypads at step S44.

When a keypad is initialized at step S45 to use the wireless network, controller 20 will wait for a talk request at step S46. If no talk request is received, but a polling command over the wired network is detected at step S54, then the received polling command is processed at step S55. Regardless of whether or not a polling command is received at step S54, the controller determines at step S56 whether there is a system message and status update. If no update is available, then the process returns to step S46. If a system message and status update is detected, then the message and update is broadcast at step S57 to all the keypads before returning to step S46.

When a talk request is received at step S46 and the controller determines at step S47 that the keypad has permission to send a request, the keypad transmits a command to the controller at step S48. A command that is a controller request at step S49 proceeds to step S41, while a command that is a keypad request is executed at step S50. Then, at step S51, the controller intelligently broadcasts the system message and status update to the controlling keypad and not to the other keypads. At step S52, the controller waits for an ACK message from the controlling keypad. If no ACK is received within a pre-determined period of time, the controlling keypad system message and status update is resent at step S53 until the ACK is received. After receiving the ACK, the process returns to step S46.

In another embodiment of the invention, a docked keypad can control a single device, a set of devices, or a single category of devices while an undocked keypad can control a different device, set of devices, or category of devices. These devices, sets of devices, or categories of device may also be based on location, device type, function or other criteria. Any logical grouping of devices may be used associated with a particular docking station or a docked or undocked state.

The particular embodiments of the invention described in this document should be considered illustrative, rather than restrictive. Modification to the described embodiments may be made without departing from the spirit of the invention as defined by the following claims and their equivalents.

I claim:

1. A remote control system comprising:
a plurality of devices located in a plurality of zones in an operational area;
a controller coupled to and controlling the plurality of devices;
a handheld control device having a first wired interface and a wireless transmitter, the wireless transmitter commanding the controller to control a first set of devices selected from the plurality of devices;
a docking station located in one of the plurality of zones; and
the docking station connected to the controller through a wired network and having a second wired interface connectable with the first wired interface when the handheld control device is docked such that the handheld control device connects to the controller through the wired network to control a second set of devices selected from the plurality of devices,
wherein the second set of devices is different from the first set of devices.

2. The remote control system of claim 1, wherein the second set of devices is a subset of the first set of devices.

3. The remote control system of claim 2, wherein the second set of devices are located in a same one of the plurality of zones as the docking station.

4. The remote control system of claim 1, wherein the first set of devices consists of all of the plurality of devices.

5. The remote control system of claim 1, wherein the wireless transmitter is adapted to connect to the controller through a wireless network.

6. The remote control system of claim 1, wherein the docking station is wall mounted.

7. A remote control system comprising:
a plurality of devices located in a plurality of zones in an operational area;
a controller coupled to and controlling the plurality of devices;
a handheld control device having a first wired interface and a wireless transmitter, the wireless transmitter commanding the controller to control a first set of devices selected from the plurality of devices using a first set of available commands; and
a docking station located in one of the plurality of zones and connected to the controller through a wired network, the docking station having a second wired interface connectable with the first wired interface when the handheld control device is docked such that the handheld control device connects to the controller through the wired network to control a second set of devices using a second set of available commands,
wherein the second set of available commands is different from the first set of available commands.

8. The remote control system of claim 7, wherein the second set of available commands is a subset of the first set of available commands.

9. The remote control system of claim 7, wherein the first set of available commands is a subset of the second set of available commands.

10. The remote control system of claim 7, wherein the first set of devices is the same as the second set of devices.

11. A method for remotely controlling a plurality of devices within a plurality of zones in an operational area, comprising:
providing a docking station within one of the plurality of zones, the docking station coupled to the plurality of devices through a wired network;
providing a handheld control device connectable with the docking station and having a wireless transmitter;
automatically allowing control of a first set of devices selected from the plurality of devices by the handheld control device through the wired network when the handheld control device is connected to the docking station; and
automatically allowing control of a second set of devices selected from the plurality of devices by the handheld control device through the wireless transmitter when the handheld control device is not connected to the docking station.

12. The method of claim 11, wherein the first set of devices is different from the second set of devices.

13. The method of claim 11, further comprising:
allowing a first set of features of the first set of devices to be controlled when the handheld control device is connected to the docking station; and
allowing a second set of features of the second set of devices to be controlled when the handheld control device is not connected to the docking station,
wherein the first set of features is different from the second set of features.

14. The method of claim 11, wherein the first set of devices is a subset of the second set of devices.

15. The method of claim 11, wherein the first set of devices is determined by the zone in which the docking station is provided.

16. The method of claim 11, wherein the automatically allowing control of the first set of devices further comprises:
preventing control of the plurality of devices through the wireless transmitter when the handheld control device is connected to the docking station.

17. The method of claim 11, further comprising:
providing a MAC address to the handheld control device;
providing a zone address to the docking station;
associating the zone address of the docking station to the handheld control device when the control device is connected to the docking station.

18. The method of claim 11, further comprising:
automatically retaining control of the first set of devices after the handheld control device is disconnected from the docking station.

19. The method of claim 11, further comprising:
communicating to a controller with the handheld control device through the wired network via a polling communication protocol when the handheld control device is connected to the docking station; and
communicating to the controller with the handheld control device through a wireless network via a non-polling communication protocol when the handheld control device is not connected to the docking station.

20. The method of claim 19, wherein the non-polling communication protocol further comprises:
transmitting a talk request on the wireless network to obtain permission to transmit commands to the second set of devices.

21. The method of claim 20, wherein the non-polling communication protocol further comprises:
transmitting commands from the handheld control device to the second set of devices;
transmitting a system update message from the controller to the handheld control device in response to the transmitted commands;
transmitting an acknowledgment message from the handheld control device to the controller if the system update message is received by the handheld control device; and
re-transmitting the system update message from the controller to the handheld control device if the system update message is not received by the handheld control device.
